(19) United States
(12) Patent Application Publication
(10) Pub. No.: US 2022/0316687 A1
(43) Pub. Date: Oct. 6, 2022

(54) STANDING LIGHT

(71) Applicant: Nanjing Chervon Industry Co., Ltd., Nanjing (CN)

(72) Inventors: Shichun Tao, Nanjing (CN); Xiang Chen, Nanjing (CN); Shubin Tong, Nanjing (CN); Tian Yu, Nanjing (CN)

(21) Appl. No.: 17/691,444

(22) Filed: Mar. 10, 2022

(30) Foreign Application Priority Data
Mar. 30, 2021 (CN) 202110337505.7
Dec. 1, 2021 (CN) 202111456863.6
Dec. 1, 2021 (CN) 202111458134.4
Dec. 1, 2021 (CN) 202123000149.4

(51) Int. Cl. F21V 21/06; F21S 9/02; F21V 23/06; F21V 23/04; F21V 23/00

(52) U.S. Cl. CPC F21V 21/06; F21S 9/02; F21V 23/06; F21V 23/04; F21V 23/002

(57) ABSTRACT

A standing light includes a light assembly, a support rod assembly, and a housing assembly. The support rod assembly is configured to support the light assembly. The housing assembly or the support rod assembly is formed with a power access interface for being connected to a power supply. The standing light further includes a mounting assembly configured to detachably install the light assembly to the support rod assembly. When the light assembly is installed to the support rod assembly, the light assembly is capable of being powered by the power supply connected to the power access interface. The light assembly is further formed with a power supply access interface for accessing power, and when the light assembly is detached from the support rod assembly, the light assembly is capable of being detachably connected to a battery pack through the power supply access interface.

### RELATED APPLICATION INFORMATION

This application claims the benefit under 35 U.S.C. § 119(a) of Chinese Patent Application No. 202110337505.7, filed on Mar. 30, 2021, Chinese Patent Application No. CN 202111456863.6, filed on Dec. 1, 2021, Chinese Patent Application No. CN 202111458134.4, filed on Dec. 1, 2021, and Chinese Patent Application No. CN 202123000149.4, filed on Dec. 1, 2021, which applications are incorporated herein by reference in their entirety.

### BACKGROUND

As a work light that can stand on the ground, a standing light is widely favored by people. An existing standing light includes a support rod assembly and a light assembly, and the light assembly generally cannot be detached from the support rod assembly and used independently, thereby limiting operating conditions of the standing light.

### SUMMARY

In one example, a standing light includes a light assembly, a support rod assembly, and a housing assembly. The light assembly includes a light. The support rod assembly is configured to support the light assembly. The housing assembly is connected to the support rod assembly, where the housing assembly is formed with a power access interface for being connected to a power supply. The standing light further includes a mounting assembly configured to detachably install the light assembly to the support rod assembly. The light assembly is further formed with a power supply access interface for accessing power, and when the light assembly is detached from the support rod assembly, the light assembly is capable of being detachably connected to a battery pack through the power supply access interface.

In one example, the battery pack connected to the light assembly is capable of supplying power to a power tool.

In one example, the mounting assembly is provided with a connecting structure for detachably connecting the light assembly to the mounting assembly and a power supply output interface for outputting power from the power access interface to the light assembly; and when the light assembly is installed to the mounting assembly through the connecting structure, the power supply output interface is electrically connected to the power supply access interface.

In one example, the housing assembly includes a base disposed at a lower end of the support rod assembly, and the mounting assembly is disposed at an upper end of the support rod assembly.

In one example, a mounting portion for installing the battery pack is provided on the base, and when the battery pack is coupled to the mounting portion, the battery pack is electrically connected to the power access interface.

In one example, the housing assembly further includes a handle housing connected to the support rod assembly, and the handle housing is formed with a handle for a user to hold.

In one example, the light assembly is formed with a mating structure mating with the connecting structure, and the battery pack is formed with a battery connecting base capable of being connected to the mating structure and a battery output interface capable of being electrically connected to the power supply access interface.

In one example, the housing assembly is formed with a mounting portion for installing the battery pack; and when the battery pack is connected to the mounting portion, the battery connecting base mates with the mounting portion, and the battery output interface is electrically connected to the power access interface.

In one example, the standing light is further provided with an alternating current access interface for accessing alternating current.

In one example, a first switch for turning on the light is formed on the support rod assembly or the housing assembly, and a second switch for turning on the light is formed on the light assembly.

Provided is a standing light, including a support rod assembly and a light assembly. The support rod assembly includes a first support rod extending substantially along a first straight line. The light assembly is disposed on an upper end of the support rod assembly and includes a main light and an auxiliary light rotatably connected to the mail light. The light assembly is rotatable relative to the support rod assembly around a first axis to a first state and a second state, where the first axis is perpendicular to the first straight line. In the case where the light assembly is in the first state, a ratio of a size of a part of the light assembly disposed on an upper side of the support rod assembly along a direction of the first straight line to a size of the light assembly along the direction of the first straight line is greater than or equal to 0.5 and less than or equal to 1; and in the case where the light assembly is in the second state, a ratio of a size of an overlapping part of the light assembly and the support rod assembly along the direction of the first straight line to the size of the light assembly along the direction of the first straight line is greater than or equal to 0.5 and less than or equal to 1.

In one example, the support rod assembly further includes a second support rod retractable relative to the first support rod along the first straight line; and the support rod assembly has a longest state and a shortest state, where in the case where the support rod assembly is in the longest state, a length of the support rod assembly is greater than or equal to 1.5 meters and less than or equal to 2.5 meters.

In one example, the second support rod is rotatable relative to the first support rod around an axis parallel to the first straight line.

In one example, in the case where the light assembly is in the second state, the auxiliary light is rotatable relative to the main light to a storage state in which the support rod assembly is disposed between the main light and the auxiliary light.

In one example, two auxiliary lights are provided, and in the case where the light assembly is in the second state and the auxiliary lights are in the storage state, the light assembly surrounds and forms a U-shaped region, and the support rod assembly is disposed within the U-shaped region.

In one example, the standing light further includes a mounting assembly for installing the light assembly on the support rod assembly, and the light assembly is detachably connected to the mounting assembly.

In one example, the first straight line is used as a center line of the support rod assembly, and a distance between the first axis and the first straight line is greater than or equal to 10 millimeters and less than or equal to 50 millimeters.

In one example, the first straight line is used as a center line of the support rod assembly, and a distance between a center of gravity of the light assembly and the first straight line is greater than or equal to 0 and less than or equal to 20 millimeters.

In one example, the light assembly is disposed on the upper side of the support rod assembly in the case where the light assembly is in the first state.

In one example, the light assembly is turned over to a lower side of the upper end of the support rod assembly in the case where the light assembly is in the second state.

Provided is a standing light, including a support rod assembly, a light assembly, a handle housing, and a switch. The support rod assembly includes a first support rod extending substantially along a direction of a first straight line and a second support rod extendable into the first support rod. The light assembly includes a light and disposed on an upper end of the support rod assembly. The handle housing is formed with a handle for a user to hold. The switch is used for the user to operate to turn on the light. The handle housing is connected to the first support rod, and the switch is disposed on the handle housing.

In one example, the handle housing is slidable relative to the first support rod to a first position and a second position along the direction of the first straight line.

In one example, the standing light further includes a leg assembly configured to support the support rod assembly on the ground, where the leg assembly includes at least three legs, and the leg assembly is connected to the handle housing.

In one example, the standing light further includes a locking assembly configured to lock sliding of the handle housing relative to the first support rod; where the locking assembly includes an operating member for the user to operate, the operating member is disposed on a handle, and the switch is disposed on the handle.

In one example, the standing light further includes a power supply housing, a circuit board, and a wire. The power supply housing is formed with the power access interface for being connected to the power supply. The circuit board is disposed in the power supply housing. The wire connects to the circuit board to the switch.

In one example, the first support rod is formed with a through hole for the wire to pass through, and the through hole is disposed in the handle housing.

In one example, the through hole is disposed in the handle housing when the handle housing slides downward to the first position; and the through hole is disposed in the handle housing when the handle housing slides upward to the second position.

In one example, the handle housing is further formed with a mounting portion for installing the battery pack.

In one example, the handle housing is slidable relative to the first support rod to a first position and a second position along the direction of the first straight line.

In one example, when the handle housing slides downward to the first position, a distance between the battery pack and a lower end of the standing light is greater than or equal to 20 millimeters and less than or equal to 80 millimeters; when the handle housing slides upward to the second position, the distance between the battery pack and the lower end of the standing light is greater than or equal to 50 millimeters and less than or equal to 110 millimeters.

### BRIEF DESCRIPTION OF DRAWINGS

FIG. 1 is a plan view of a standing light in an operating state according to a first example;

FIG. 2 is a plan view of the standing light in FIG. 1 in a storage state;

FIG. 3 is a perspective view of the standing light in FIG. 1 in a storage state;

FIG. 4 is a perspective view of the standing light in FIG. 1;

FIG. 5 is another perspective view of the standing light in FIG. 1;

FIG. 6 is a perspective view of a second support rod, a mounting assembly, and a light assembly of the standing light in FIG. 1;

FIG. 7 is another perspective view of a structure in FIG. 6;

FIG. 8 is a perspective view of a light assembly in FIG. 1 when a battery pack is installed;

FIG. 9 is another perspective view of a structure in FIG. 8;

FIG. 10 is a perspective view of the light assembly in FIG. 8 when the battery pack is detached;

FIG. 11 is another perspective view of a structure in FIG. 10;

FIG. 12 is part of a sectional view of the standing light in FIG. 1;

FIG. 13 is an enlarged view of part of a region of a structure in FIG. 12;

FIG. 14 is a sectional view of the standing light in FIG. 2;

FIG. 15 is a perspective view of the light assembly and the battery pack in FIG. 8 when a bracket is in a support state;

FIG. 16 is a perspective view of a second support rod, a mounting assembly, and a light assembly in FIG. 1 when the light assembly is turned over to a second state;

FIG. 17 is a perspective view of a second support rod, a mounting assembly, and a light assembly in FIG. 1 in a storage state;

FIG. 18 is a plan view of a power tool;

FIG. 19 is a plan view of a standing light in an operating state according to a second example;

FIG. 20 is a plan view of the standing light in FIG. 19 in a storage state;

FIG. 21 is a plan view of a standing light in an operating state according to a third example;

FIG. 22 is a sectional view of the standing light in FIG. 21;

FIG. 23 is an enlarged view of region A in FIG. 22;

FIG. 24 is an enlarged view of region B in FIG. 22;

FIG. 25 is a perspective view of a standing light according to a fourth example;

FIG. 26 is an enlarged view of region C in FIG. 25;

FIG. 27 is a plan view of a standing light in a first state according to a fifth example;

FIG. 28 is a plan view of the standing light in FIG. 27 in a second state;

FIG. 29 is a perspective view of a partial structure of the standing light in FIG. 27;

FIG. 30 is a perspective view of a standing light in a storage state according to a sixth example; and

FIG. 31 is a perspective view of the standing light in FIG. 30 when a protective cover is detached.

### DETAILED DESCRIPTION

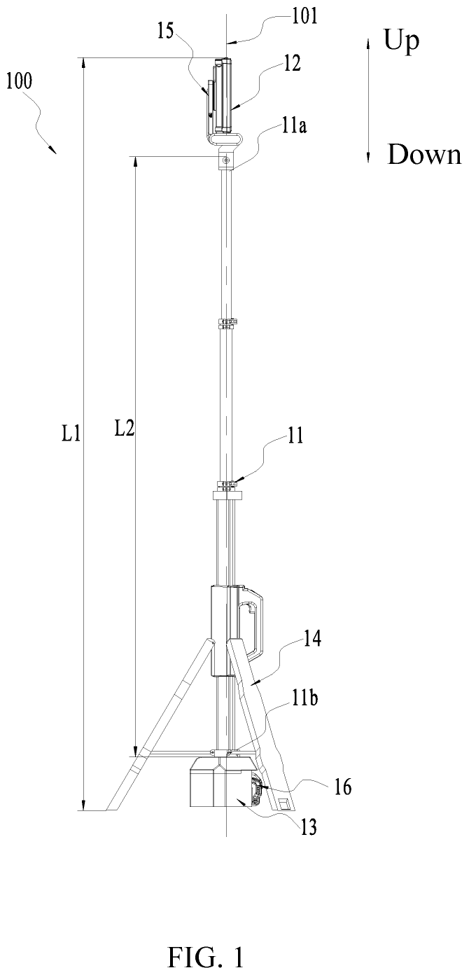

A standing light 100 in a first example shown in FIG. 1 is configured to illuminate an operating region. The standing light 100 is a portable bracket light that is easy to carry. When a user needs to work outdoors, the user may bring the standing light 100 to the outdoors, thereby satisfying lighting requirements. The standing light 100 is different from a desk light, which is generally placed on a desktop for lighting, but the standing light 100 in FIG. 1 generally stands on the ground to illuminate the operating region when in use, so the standing light 100 may also be called as a ground standing light.

The standing light 100 in FIG. 1 may be powered by a battery pack 16 so that even when the user works outdoors and no commercial power is provided around, the battery pack 16 may be used for powering the standing light 100, which is convenient for the user to use. Therefore, the standing light 100 is different from an existing light that can only be powered by alternating current, and the standing light 100 may also be called as a direct current standing light. It is to be understood that the direct current standing light is not limited to using only the battery pack 16 for power supply. If the standing light 100 may be powered by both the battery pack 16 and the alternating current, the standing light 100 may also be called the direct current standing light.

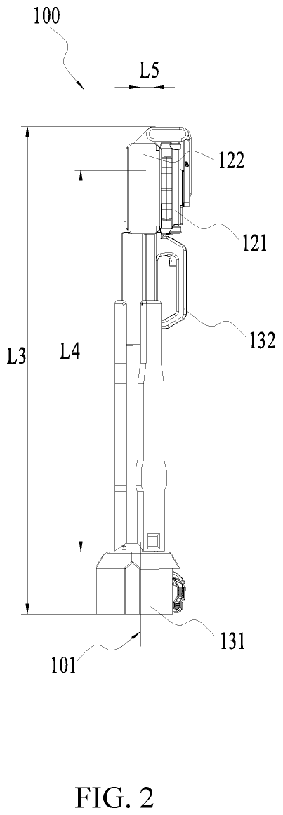

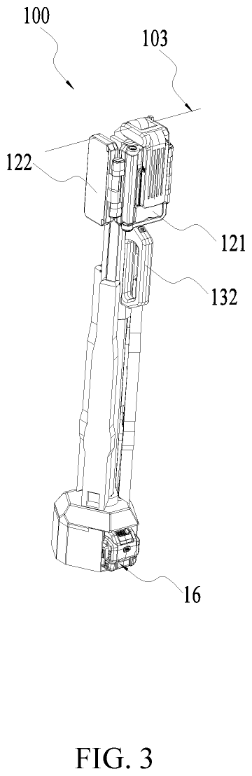

As shown in FIGS. 1 and 2, the standing light 100 has an operating state and a storage state. When the standing light 100 is in the operating state shown in FIG. 1, the user may use the standing light 100 to illuminate the operating area. When the standing light 100 is in the storage state shown in FIGS. 2 and 3, the user may easily carry the standing light 100.

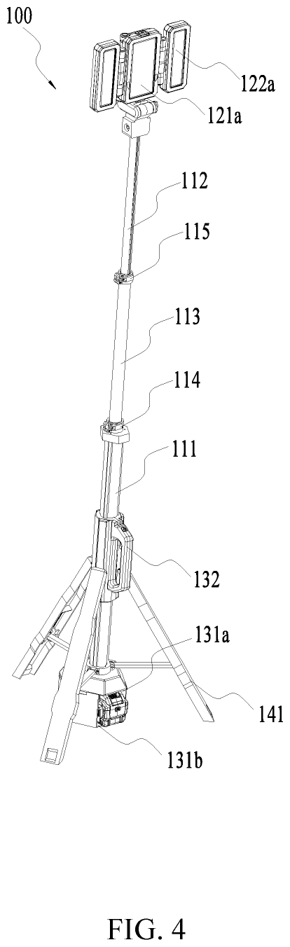

As shown in FIGS. 1 to 5, the standing light 100 includes a support rod assembly 11, a light assembly 12, a housing assembly 13, and a leg assembly 14. The support rod assembly 11 is configured to support the light assembly 12, and the support rod assembly 11 includes at least one support rod extending along a first straight line 101. In this example, the support rod assembly 11 includes three support rods, which are a first support rod 111, a second support rod 112, and a third support rod 113, respectively. The first support rod 111, the second support rod 112, and the third support rod 113 all extend along a direction of the first straight line 101. The first support rod 111 extends along the direction of the first straight line 101, the second support rod 112 is retractable relative to the first support rod 111 along the direction of the first straight line 101, and the third support rod 113 connects the first support rod 111 to the second support rod 112. The third support rod 113 is disposed between the first support rod 111 and the second support rod 112. The third support rod 113 is retractable relative to the first support rod 111, and part of the third support rod 113 can be retracted into the first support rod 111. The second support rod 112 is retractable relative to the third support rod 113, and part of the second support rod 112 can be retracted into the third support rod 113. The support rod assembly 11 has a longest state and a shortest state. As shown in FIG. 1, the standing light 100 is in the operating state; at this time, the support rod assembly 11 is in the longest state, the third support rod 113 slides to the uppermost relative to the first support rod 111, and the second support rod 112 slides to the uppermost relative to the third support rod 113. As shown in FIGS. 2 and 3, the standing light 100 is in the storage state; at this time, the support rod assembly 11 is in the shortest state, the third support rod 113 slides to the lowermost relative to the first support rod 111, and the second support rod 112 slides to the lowermost relative to the third support rod 113.

The second support rod 112 is also rotatable relative to the first support rod 111 around an axis parallel to the first straight line 101. In this example, the axis of rotation of the second support rod 112 relative to the first support rod 111 coincides with the first straight line 101. In this manner, the user may rotate the first support rod 111 to make the light assembly 12 face different directions, so as to easily adjust a lighting direction of the light assembly 12 without moving the standing light 100.

When the standing light 100 is in the operating state, the support rod assembly 11 is in the longest state, a height L1 of the standing light 100 is greater than or equal to 1.8 meters and less than or equal to 3 meters, and a length L2 of the support rod assembly 11 is greater than or equal to 1.5 meters and less than or equal to 2.5 meters. When the standing light 100 is in the storage state, the support rod assembly 11 is in the shortest state, a height L3 of the standing light 100 is greater than or equal to 0.8 meters and less than or equal to 1.5 meters, and a length L4 of the support rod assembly 11 is greater than or equal to 0.6 meters and less than or equal to 1.3 meters. In this manner, when the standing light 100 is in the operating state, the height of the standing light 100 is sufficiently high so that a region illuminated by the standing light 100 is larger. When the standing light 100 is in the storage state, the height of the standing light 100 is sufficiently low so that it is convenient for the user to store and carry the standing light 100. The length of the support rod assembly 11 refers to a distance between a lower end 11b of the first support rod 111 and an upper end 11a of the second support rod 112.

A first locking member 114 is further disposed between the first support rod 111 and the third support rod 113, and the first locking member 114 can lock the third support rod 113 to any position relative to the first support rod 111. A second locking member 115 is further disposed between the second support rod 112 and the third support rod 113, and the second locking member 115 can lock the second support rod 112 to any position relative to the third support rod 113. In this manner, the support rod assembly 11 may be fixed in any state between the longest state and the shortest state. Therefore, the standing light 100 can be adapted to more operating environments and satisfy different requirements of users. In this example, the first support rod 111, the second support rod 112, and the third support rod 113 are all hollow rods. The first support rod 111, the second support rod 112, and the third support rod 113 are all cylindrical rods.

The support rod assembly 11 includes the upper end 11a and the lower end 11b, the upper end 11a may be understood as an upper part of the second support rod 112, and the lower end 11b may be understood as a lower part of the first support rod 111.

The light assembly 12 is disposed on the upper end 11a of the support rod assembly 11. The second support rod 112 is further provided with a mounting assembly 15 configured to detachably install the light assembly 12 on the support rod assembly 11.

The light assembly 12 includes a main light 121 and two auxiliary lights 122, and the main light 121 is disposed between the two auxiliary lights 122. In another example, the light assembly 12 may include only the main light 121. Alternatively, in another example, the light assembly 12 may include one main light 121 and one auxiliary light 122. Alternatively, in another example, the light assembly 12 may include one main light 121 and more than three auxiliary lights 122.

In this example, the main light 121 has a main exit surface 121a, and the main exit surface 121a is made of a light-transmitting material. The main exit surface 121a is substantially rectangular, and an area of the main exit surface 121a is greater than or equal to 10000 square millimeters and less than or equal to 22000 square millimeters. In an example, the area of the main exit surface 121a is greater than or equal to 12000 square millimeters and less than or equal to 20000 square millimeters. In this manner, the area of the main exit surface 121a is larger so that more regions can be illuminated. The auxiliary light 122 includes an auxiliary exit surface 122a, and the auxiliary exit surface 122a is also made of a light-transmitting material. The auxiliary exit surface 122a is substantially rectangular, and an area of the auxiliary exit surface 122a is greater than or equal to 4000 square millimeters and less than or equal to 12000 square millimeters. The area of the main exit surface 121a is greater than the area of the auxiliary exit surface 122a.

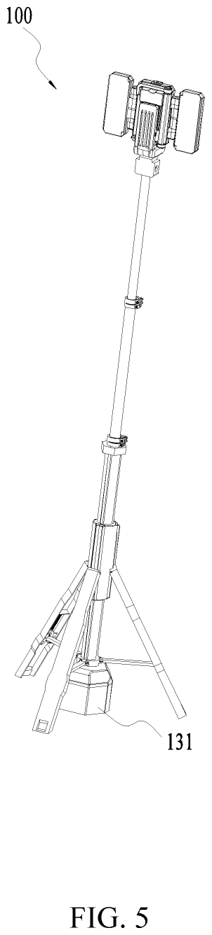

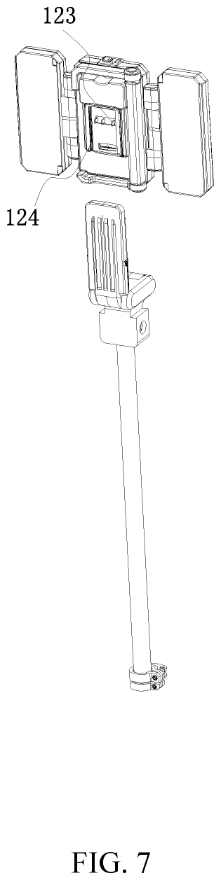

As shown in FIGS. 5 to 7, the mounting assembly 15 is disposed at the upper end 11a of the support rod assembly 11 and configured to install the light assembly 12 on the support rod assembly 11. The mounting assembly 15 is provided with a connecting structure 151 and a power supply output interface 152, and the light assembly 12 is formed with a power supply access interface 123 for mating with the power supply output interface 152. The connecting structure 151 is configured to detachably connect the light assembly 12 to the mounting assembly 15. The connecting structure 151 can guide the light assembly 12 to be coupled to the mounting assembly 15 along a second straight line 102. When the standing light 100 is in the operating state shown in FIG. 1, the second straight line 102 along which the light assembly 12 is coupled to the mounting assembly 15 is parallel to the first straight line 101. Alternatively, in another example, when the standing light is in the operating state, the second straight line along which the light assembly is coupled to the mounting assembly coincides with the first straight line. The light assembly 12 can be plugged and unplugged by the user along a direction of the second straight line 102. In this manner, the light assembly 12 may be installed to the support rod assembly 11 so that the light assembly 12 and the support rod assembly 11 form the standing light 100 for use, which is convenient for the standing light 100 to illuminate higher and further regions. On the other hand, the light assembly 12 may also be detached to be used as a small work light. At this time, the light assembly 12 can illuminate relatively narrow places, and the light assembly 12 may also be freely placed on a workbench or other objects, thereby improving an application range of the light assembly 12.

The power supply output interface 152 is used for outputting power, and the power supply access interface 123 is used for receiving power. The power supply output interface 152 mates with the power supply access interface 123. When the light assembly 12 is installed to the mounting assembly 15 through the connecting structure 151, and the power supply output interface 152 is electrically connected to the power supply access interface 123. The housing assembly 13 includes a base 131, and a power access interface 131a for being connected to a power supply device is formed on the base 131. In this manner, the power supply output interface 152 may output power from the power access interface 131a to the light assembly 12. Therefore, when the light assembly 12 is installed to the mounting assembly 15, the light assembly 12 may be powered by the power supply device disposed on the housing assembly 13. In this example, the power supply device is the battery pack 16. When the light assembly 12 is installed to the support rod assembly 11, the light assembly 12 is powered by the power supply connected to the power access interface 131a, that is, powered by the battery pack 16 connected to the power access interface 131a.

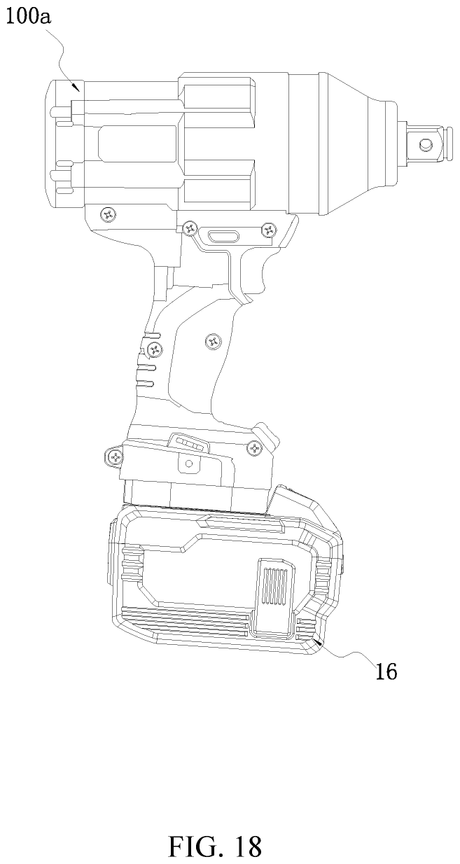

When the light assembly 12 is detached from the support rod assembly 11, the light assembly 12 may be detachably connected to the battery pack 16 through the power supply access interface 123. The battery pack 16 connected to the light assembly 12 can supply power to another power tool 100a shown in FIG. 18. For example, the battery pack 16 can not only be used for supplying power to the light assembly 12 but also can be used for supplying power to other hand-held power tools 100a. For example, the battery pack 16 can supply power to drill tools, such as an electric drill and a screwdriver, saw tools. such as a circular saw and a reciprocating saw, abrasive tools, such as an angle grinder and a sander, garden tools, such as a grass trimmer, a lawn mower, and a hair dryer, and a snow plow. That is, the battery pack 16 has a relatively wide application range and is a general-purpose battery pack. The battery pack 16 can not only be installed to the base 131 of the standing light 100, the battery pack 16 can also be installed to the light assembly 12 when the light assembly 12 is detached, and the battery pack 16 may also supply power to other types of power tools 100a.

In this example, the light assembly 12 is mechanically and electrically connected to the support rod assembly 11 through the mounting assembly 15 so that when the light assembly 12 is installed to the mounting assembly 15, the light assembly 12 is not provided with a power supply device, thereby facilitating the setting of a center of gravity of the standing light 100 and improving the balance performance of the standing light 100. Moreover, since the light assembly 12 is provided with the power supply access interface 123, when the light assembly 12 is detached from the mounting assembly 15, the user may directly install the power supply device to the power supply access interface 123 so that the light assembly 12 may be used independently.

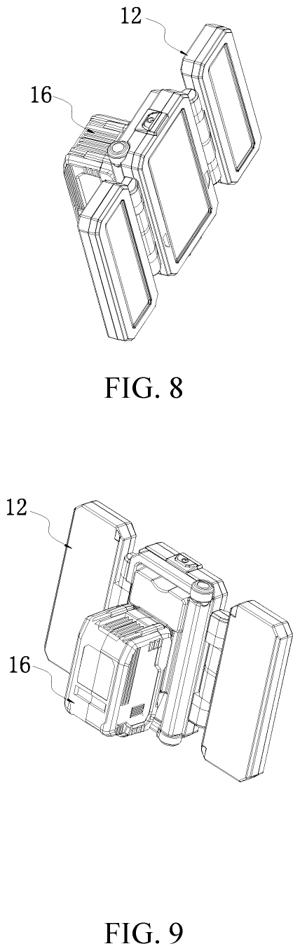

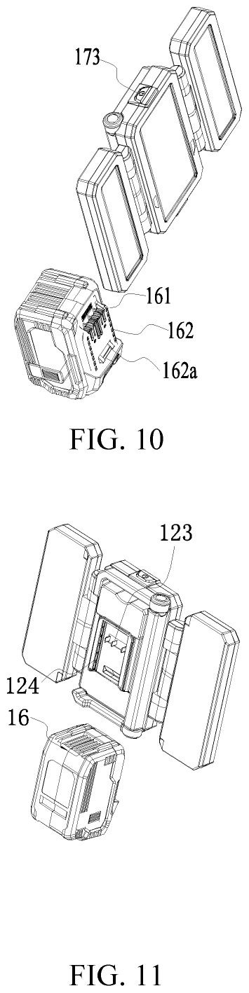

As shown in FIG. 3 and FIGS. 8 to 11, in this example, the standing light 100 further includes the battery pack 16 for providing a power source. The battery pack 16 can be directly installed to the support rod assembly 11 or the housing assembly 13 so that when the light assembly 12 is installed to the mounting assembly 15, the battery pack 16 can supply power to the light assembly 12 through the power supply output interface 152 and the power supply access interface 123. The battery pack 16 is provided with a battery output interface 161 so that when the light assembly 12 is detached and used independently, the battery pack 16 can be directly coupled to the light assembly 12, thereby supplying power to the light assembly 12 through the battery output interface 161 on the battery pack 16 and the power supply access interface 123.

The light assembly 12 is provided with a mating structure 124 mating with the connecting structure 151. The connecting structure 151 and the mating structure 124 can guide the light assembly 12 to be coupled to the mounting assembly 15 along the second straight line 102. Similarly, the battery pack 16 is provided with a battery connecting base 162 that is substantially the same as the connecting structure 151, and the battery connecting base 162 mates with the mating structure 124. The battery connecting base 162 and the mating structure 124 can guide the light assembly 12 to be coupled to the battery pack 16 along the direction of the second straight line 102, or the battery connecting base 162 and the mating structure 124 can guide the battery pack 16 to be coupled to the light assembly 12 along the direction of the second straight line 102.

In this example, whether the light assembly 12 is installed to or detached from the support rod assembly 11, the light assembly 12 can be powered by the battery pack 16. The power supply access interface 123 disposed on the light assembly 12 may be electrically connected to both the power supply output interface 152 on the mounting assembly 15 and the battery output interface 161 on the battery pack 16. Moreover, the mating structure 124 disposed on the light assembly 12 may be mechanically connected to the connecting structure 151 on the mounting assembly 15 and may also be mechanically connected to the battery connecting base 162 on the battery pack 16. Moreover, when the light assembly 12 is connected to the connecting structure 151 through the mating structure 124, the power supply access interface 123 is aligned with and electrically connected to the power supply output interface 152. When the light assembly 12 is connected to the battery connecting base 162 through the mating structure 124, the power supply access interface 123 is aligned with and electrically connected to the battery output interface 161. Therefore, the adaptability of the standing light 100 is improved, and it is convenient for the user to use the standing light 100.

The housing assembly 13 further includes a handle housing 132. The base 131 is disposed on the lower end 11b of the support rod assembly 11, and the handle housing 132 is connected to the first support rod 111. In this example, a mounting portion 131b is formed on the base 131, and the battery pack 16 can be installed to the base 131. That is, when the light assembly 12 is installed to the mounting assembly 15, the battery pack 16 is disposed on the base 131, the battery connecting base 162 mates with the mounting portion 131b, and the battery output interface 161 is electrically connected to the power access interface 131a. At this time, the light assembly 12 is powered by the battery pack 16 on the base 131. In this example, the base 131 is a power supply housing formed with the power access interface 131a for being connected to the power supply device. In another example, the power supply housing may not be disposed on the lower end 11b of the support rod assembly 11, but may be disposed at other positions of the support rod assembly 11.

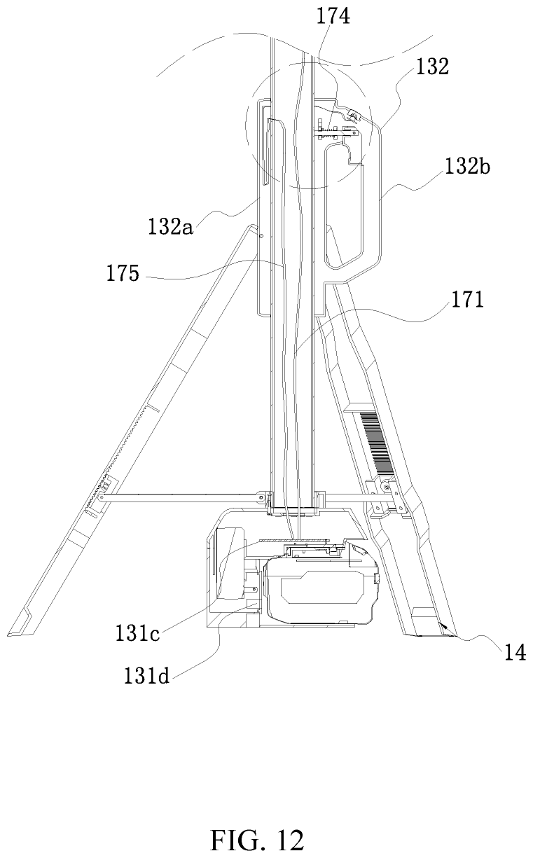

As shown in FIGS. 12 to 14, a circuit board 131c is further provided in the base 131, and the circuit board 131c is configured to be electrically connected to the battery pack 16. The standing light 100 further includes a first wire 171 that is electrically connected to the circuit board 131c and the power supply output interface 152. The first wire 171 passes through the support rod assembly 11. In one example, to facilitate extension and retraction of the support rod assembly 11, the first wire 171 may be a helical wire.

The base 131 is further provided with an alternating current access interface 131d for accessing external alternating current. In this manner, when power of the battery pack 16 is insufficient or the standing light 100 is relatively close to the mains socket, the standing light 100 may be connected to the mains to operate.

The handle housing 132 is connected to the first support rod 111. The handle housing 132 includes a surrounding portion 132a surrounding the first support rod 111 and a handle 132b for the user to hold. When the standing light 100 is in the storage state, the user may hold the handle 132b to carry the standing light 100.

The standing light 100 further includes a first switch 172 for turning on the main light 121 and the auxiliary light 122, where the first switch 172 may be disposed on the support rod assembly 11 or the housing assembly 13. In this example, the first switch 172 is disposed on the handle housing 132, and further, the first switch 172 is disposed on the handle 132b. In this manner, when the user needs to use the standing light 100, the user may hold the handle 132b at will to press the first switch 172.

The standing light 100 further includes a second switch 173 for turning on the main light 121 and the auxiliary light 122, where the second switch 173 is disposed on the light assembly 12. In this manner, when the light assembly 12 is detached from the support rod assembly 11 and used independently, the user may turn on the light by operating the second switch 173 on the light assembly 12.

The first switch 172 may independently turn on or off the light assembly 12, and the second switch 173 may also independently turn on or off the light assembly 12. The first switch 172 further has multiple gears such as a power-on gear, an intermediate gear, an advanced gear, and a shutdown gear. When the first switch 172 is triggered to enter the power-on gear for the first time, the first switch 172 may turn on the light assembly 12, and the light assembly 12 has a first brightness at this time. For the second time, the first switch 172 is triggered to enter the intermediate gear, and the light assembly 12 has a second brightness at this time. For the third time, the first switch 172 is triggered to enter the advanced gear, and the light assembly 12 has a third brightness. For the fourth time, the first switch 172 is triggered to enter the shutdown gear, and the light assembly 12 is turned off. The first brightness is lower than the second brightness, and the second brightness is lower than the third brightness. It is to be understood that the gear setting and control logic of the first switch 172 are not limited thereto. In this example, the gear setting and control logic of the second switch 173 are the same as those of the first switch 172. It is to be understood that, in another example, the gear setting and control logic of the second switch 173 may also be different. In this example, the first switch 172 and the second switch 173 are connected in parallel.

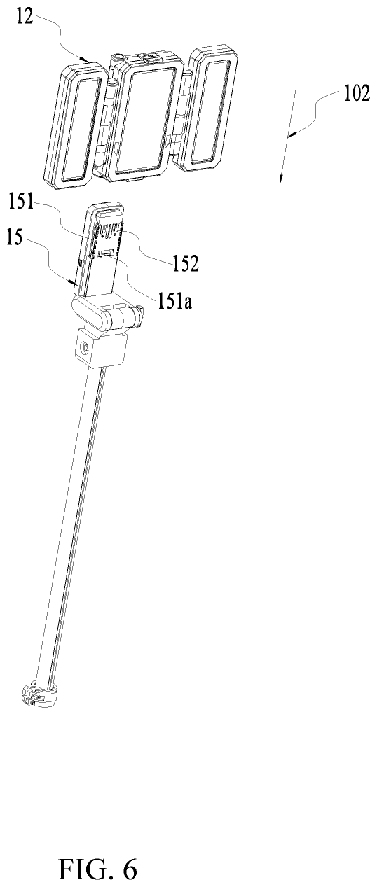

As shown in FIG. 6, the connecting structure 151 is further provided with a locking member 151a configured to lock the light assembly 12 to the mounting assembly 15. The locking member 151a has a locked state and an unlocked state. The locking member 151a can lock the light assembly 12 to the mounting assembly 15 when the locking member 151a is in the locked state. The locking member 151a allows the light assembly 12 to be detached from the mounting assembly 15 when the locking member 151a is in the unlocked state. In this example, the locking member 151a is a protrusion. Correspondingly, the light assembly 12 is provided with a groove mating with the protrusion. Similarly, to achieve fixation between the battery pack 16 and the light assembly 12, another locking member 162a with the same structure as the locking member 151a is provided on the battery pack 16.

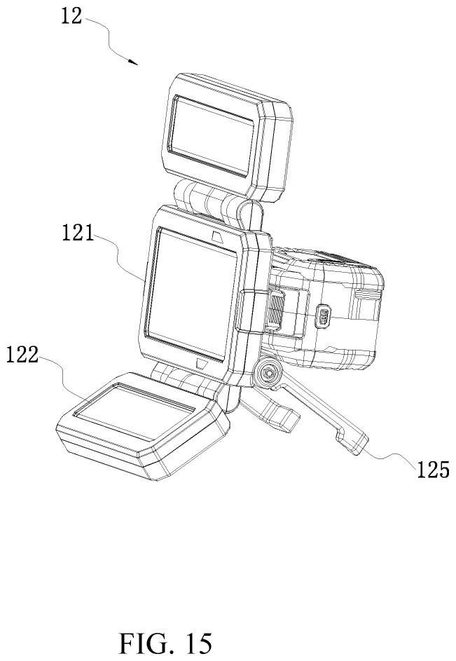

As shown in FIG. 15, the light assembly 12 further includes a bracket 125, where the bracket 125 is rotatably connected to the main light 121. After the light assembly 12 is detached from the support rod assembly 11, the light assembly 12 is installed with the battery pack 16 to operate, and the bracket 125 can rotate relative to the main light 121 to a support state shown in FIG. 15. At this time, the light assembly 12 may be supported on the workbench by the auxiliary light 122 and the bracket 125.

As shown in FIGS. 1 to 3, the light assembly 12 is rotatable relative to the support rod assembly 11 around a first axis 103 to a first state and a second state, where the first axis 103 is perpendicular to the first straight line 101.

When the standing light 100 is in the operating state shown in FIG. 1, the light assembly 12 is in the first state. At this time, a ratio of a size of a part of the light assembly 12 disposed on an upper side of the support rod assembly 11 along the direction of the first straight line 101 to a size of the light assembly 12 along the direction of the first straight line 101 is greater than or equal to 0.5 and less than or equal to 1. Furthermore, in this example, when the light assembly 12 is in the first state, the light assembly 12 is completely disposed on the upper side of the support rod assembly 11, that is, the ratio of the size of the part of the light assembly 12 disposed on the upper side of the support rod assembly 11 along the direction of the first straight line 101 to the size of the light assembly 12 along the direction of the first straight line 101 is equal to 1. In this manner, the light assembly 12 can illuminate a larger region.

When the standing light 100 is in the storage state shown in FIGS. 2 and 3, the light assembly 12 rotates around the first axis 103 to the second state. At this time, a ratio of a size of an overlapping part of the light assembly 12 and the support rod assembly 11 along the direction of the first straight line 101 to the size of the light assembly 12 along the direction of the first straight line 101 is greater than or equal to 0.5 and less than or equal to 1. Furthermore, in this example, when the light assembly is in the second state, the entire light assembly 12 is disposed on a lower side of the upper end 11a of the support rod assembly 11. That is, the light assembly 12 is turned over to a state where the light assembly 12 overlaps with the support rod. In this manner, the ratio of the size of the overlapping part of the light assembly 12 and the support rod assembly 11 along the direction of the first straight line 101 to the size of the light assembly 12 along the direction of the first straight line 101 is equal to 1. In this manner, a volume of the standing light 100 in the storage state can be further reduced.

The mounting assembly 15 further includes a limiting member 153 for restricting the mounting assembly 15 from rotating relative to the support rod assembly 11. In this manner, when the light assembly 12 is in the first state, the limiting member 153 can restrict the light assembly 12 in the first state, so as to prevent the light assembly 12 from shaking.

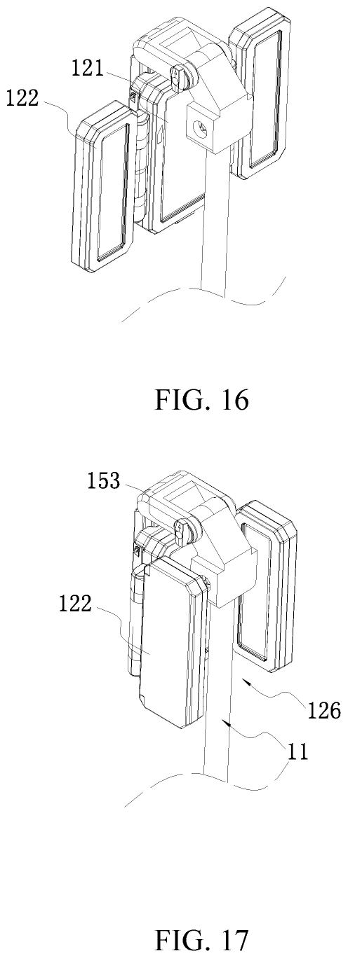

As shown in FIGS. 15 to 17, the auxiliary light 122 can rotate relative to the main light 121. When the light assembly 12 is in the second state shown in FIG. 17, the user may rotate the auxiliary light 122 from the state shown in FIG. 16 to the storage state shown in FIG. 17. At this time, the support rod assembly 11 is disposed between the main light 121 and the auxiliary light 122, the standing light 100 is in the storage state, and a space occupied by the standing light 100 can be further reduced.

As shown in FIG. 15, when the light assembly 12 is used independently, the auxiliary light 122 may also be rotated so that the light assembly 12 is supported on the workbench.

The main light 121 is disposed between two auxiliary lights 122. When the standing light 100 is in the storage state, the light assembly 12 surrounds and forms a U-shaped region 126, and the support rod assembly 11 is disposed within the U-shaped region 126.

In this example, the first straight line 101 is a center line of the support rod assembly 11, and a distance L5 between the first axis 103 and the first straight line 101 is greater than or equal to 10 millimeters and less than or equal to 50 millimeters so that when the light assembly 12 is turned over to the second state, the light assembly 12 does not interfere with the support rod assembly 11. Moreover, a distance between a center of gravity of the light assembly 12 and the first straight line 101 may be relatively small. For example, in this example, the distance between the center of gravity of the light assembly 12 and the first straight line 101 is greater than or equal to 0 and less than or equal to 20 millimeters, which is conducive to improving the stability of the standing light 100.

The leg assembly 14 is configured to support the support rod assembly 11 on the ground, and the leg assembly 14 is connected to the handle housing 132. The leg assembly 14 includes at least three legs 141, and the three legs 141 are rotatably connected to the handle housing 132, respectively. When the three legs 141 are unfolded, the leg assembly 14 can support the support rod assembly 11 on the ground so that the standing light 100 can stand on the ground. When the three legs 141 are retracted, the space occupied by the standing light 100 is reduced, thereby facilitating storage.

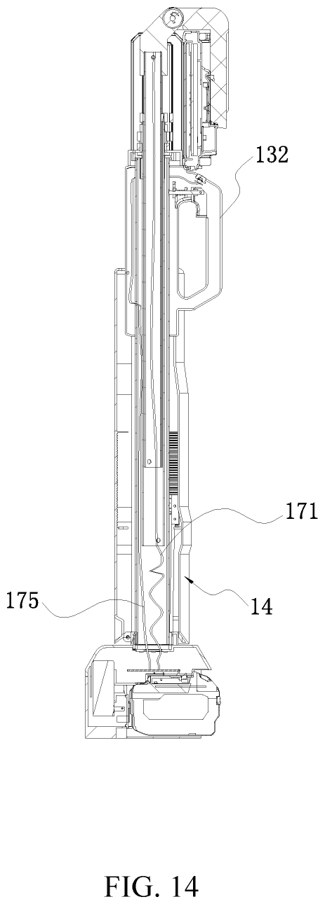

The handle housing 132 is slidably connected to the first support rod 111, and the handle housing 132 can slide to the first position and the second position relative to the first support rod 111. As shown in FIG. 12, the handle housing 132 slides upward to the lowermost first position, and the leg assembly 14 is unfolded at this time. As shown in FIG. 14, the handle housing 132 slides upward to the uppermost second position, and the leg assembly 14 is retracted at this time. The first position is a limit position where the handle housing 132 slides downward relative to the first support rod 111, and the second position is a limit position where the handle housing 132 slides upward relative to the first support rod 111. To fix the position of the handle housing 132 relative to the first support rod 111, the standing light 100 further includes a locking assembly 174 configured to lock sliding of the handle housing 132 relative to the first support rod 111. The locking assembly 174 includes an operating member 174a for the user to operate and a locking pin 174b configured to lock the handle housing 132 to the first or the second position. The operating member 174a is disposed on the handle 132b, thereby facilitating the operation of the user.

The standing light 100 further includes a second wire 175 for connecting the circuit board 131c to the first switch 172, and at least part of the second wire 175 is disposed in the first support rod 111. The first support rod 111 is provided with a through hole 111a for the second wire 175 to pass through. The second wire 175 passes through the through hole 111a from the inside of the first support rod 111 and protrudes into the surrounding portion 132a. The surrounding portion 132a communicates with the handle 132b, and the second wire 175 can extend from the surrounding portion 132a into the handle 132b and then is connected to the first switch 172.

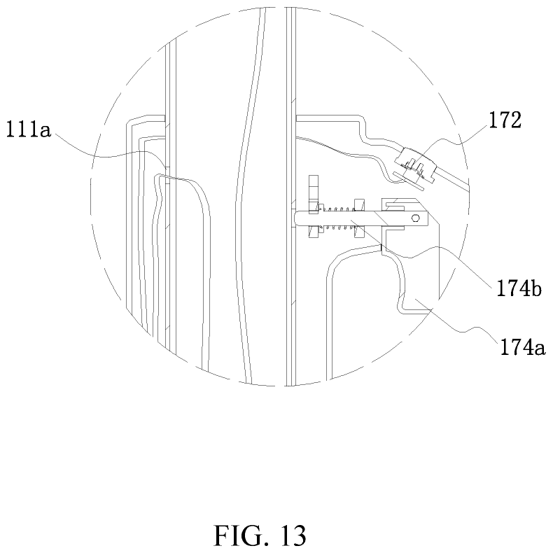

As shown in FIG. 13, the through hole 111a is disposed in the surrounding portion 132a of the handle housing 132. When the handle housing 132 slides upward to the second position, the through hole 111a is disposed in the handle housing 132. When the handle housing 132 slides downward to the first position, the through hole 111a is also disposed in the handle housing 132. That is, whether the handle housing 132 slides downward to the lowermost first position or the handle housing 132 slides upward to the uppermost second position, the through hole 111a is disposed in the surrounding portion 132a, and the second wire 175 is not exposed to the outside of the handle housing 132, thereby protecting the second wire 175.

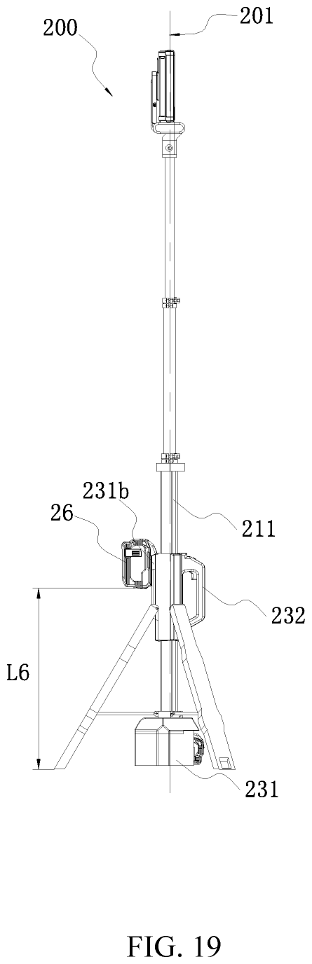

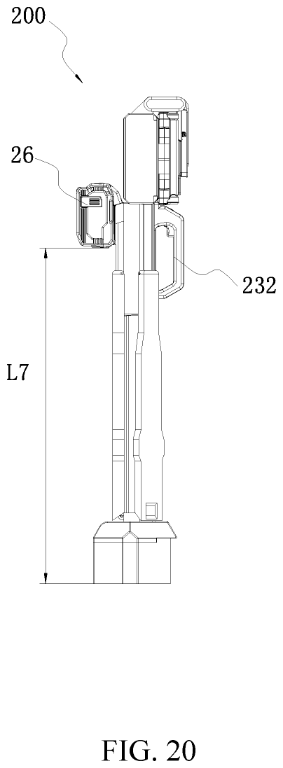

As shown in FIGS. 19 and 20, a mounting portion 231b for installing a battery pack 26 is formed on a handle housing 232 of a standing light 200 in a second example. In this example, the mounting portion 231b is not disposed on the base 231 but is disposed on the handle housing 232. In this manner, when the handle housing 232 slides relative to the first support rod 211 to the first position and the second position along the first straight line 201, the battery pack 26 also slides along with the handle housing 232. Therefore, when the standing light 200 is in the operating state shown in FIG. 19, the handle housing 232 slides downward to the first position, and a position of the battery pack 26 also moves downward so that the center of gravity of the entire standing light 200 may be lowered, and thus it is helpful for the standing light 200 to stand on the ground more stably. When the standing light 200 is in the storage state shown in FIG. 20, the handle housing 232 moves upward to the second position, and the position of the battery pack 26 also moves upward so that the center of gravity of the standing light 200 is closer to a position of the handle housing 232, and it is helpful for the user to carry the standing light 200 in a more labor-saving and stable manner.

In this example, when the handle housing 232 slides downward to the first position, a distance L6 between the battery pack 26 and a lower end of the standing light 200 is greater than or equal to 20 millimeters and less than or equal to 80 millimeters. When the handle housing 232 slides upward to the second position, a distance L7 between the battery pack 26 and the lower end of the standing light 200 is greater than or equal to 50 millimeters and less than or equal to 110 millimeters. The distance L6 between the battery pack 26 and the lower end of the standing light 200 is less than the distance L7 between the battery pack 26 and the lower end of the standing light 200.

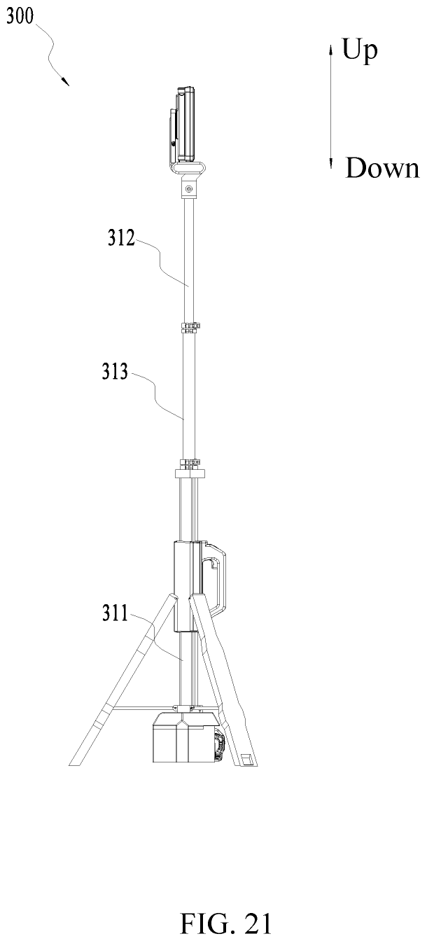

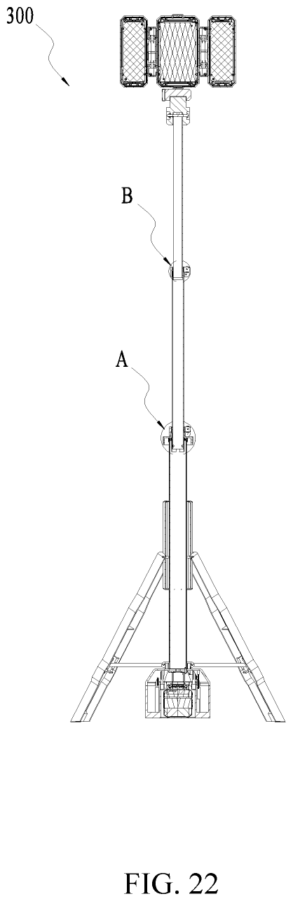

FIGS. 21 and 22 show a standing light 300 in a third example. Differences between the standing light 300 and the standing light 100 in the first example only lie in that a connecting structure at the first support rod 311 and the third support rod 313 is different from that in the first example and a connecting structure of the third support rod 313 and the second support rod 312 is different from that in the first example. It is to be understood that the preceding connecting structure may actually be applied to the standing light 100 in the first example.

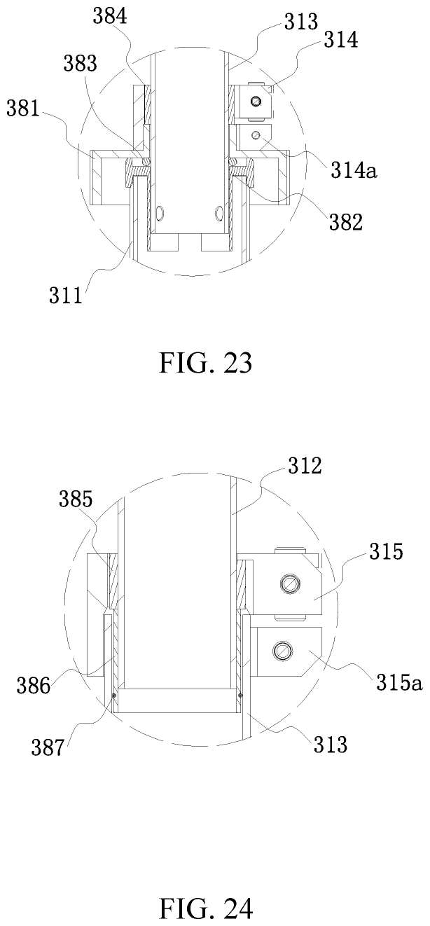

As shown in FIG. 23, the standing light 300 further includes a cover plate 381 connected to the first support rod 311, the cover plate 381 is fixedly connected to the first support rod 311 through a connector 382, a gap is further formed between the cover plate 381 and the connector 382, and a first rubber ring 383 is disposed in the gap. The first locking member 314 includes a first locking portion 314a and a first operating portion. One end of the first locking portion 314a is fixedly connected to the cover plate 381, and the other end of the first locking portion 314a is connected to a C-shaped first lighting member 384. When the user operates the first operating portion, the first locking portion 314a applies pressure to the first lighting member 384 so that the first lighting member 384 lights the third support rod 313. The first rubber ring 383 is further sleeved on the third support rod 313, an inner wall of the first rubber ring 383 is in contact with the third support rod 313, an upper wall of the first rubber ring 383 is in contact with the cover plate 381, and a lower wall of the first rubber ring 383 is in contact with the connector 382, thereby achieving sealing between the third support rod 313 and the first support rod 311.

As shown in FIG. 24, a C-shaped second lighting member 385 is sleeved on the second support rod 312, and a second locking member 315 includes a second locking portion 315a and a second operating portion. One end of the second locking portion 315a is connected to the third support rod 313, and the other end of the second locking portion 315a is connected to the second lighting member 385. When the user operates the second operating portion, the second locking portion 315a applies pressure to the second lighting member 385, and the second lighting member 385 locks the second support rod 312 to the third support rod 313. A bushing 386 is further fixed on the second support rod 312, a groove is formed on the bushing 386, and a second rubber ring 387 is disposed in the groove. An inner wall of the second rubber ring 387 is in contact with the groove, and an outer wall of the second rubber ring 387 is in contact with the third support rod 313, thereby achieving sealing between the second support rod 312 and the third support rod 313.

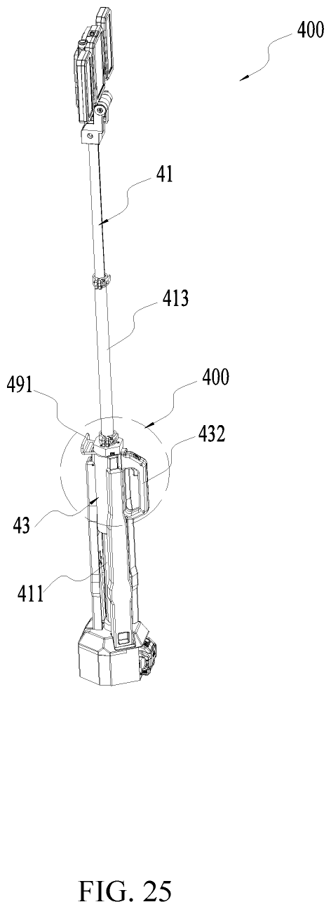

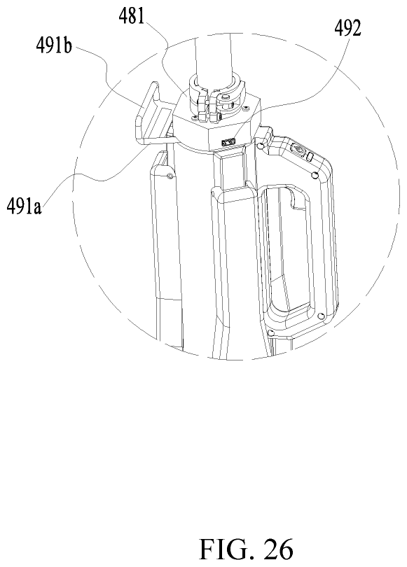

As shown in FIG. 25, the standing light 400 in a fourth example has substantially the same structure as the standing light 100 in the first example. As shown in FIGS. 25 and 26, a main difference between the standing light 400 and the standing light 100 in the first example is that the standing light 400 in this example further includes a bracket 491 and a charging interface 492.

In an example, the bracket 491 is a rack for supporting a mobile phone. It is to be understood that the function of the bracket 491 is not limited to this, for example, the bracket 491 may also be used for placing a tablet computer, or other accessories or supplies that the user needs to use. The function of the bracket 491 is not limited to supporting objects, and the bracket 491 may also be used for hanging some objects, that is, the bracket 491 also functions as a hook. The bracket 491 includes a mounting portion 491a and a supporting portion 491b. The mounting portion 491a is configured to install the bracket 491 to a main body of the standing light 400, for example, the bracket 491 may be installed to the support rod assembly 41 or the housing assembly 43. In this example, the bracket 491 is installed to a connecting structure 481 at a position where the first support rod 411 is connected to the third support rod 413. In this manner, a height of the bracket 491 in a vertical direction is moderate, on the one hand, it is convenient for the user to place the mobile phone on the bracket 491; on the other hand, the height of the bracket 491 is not too large so that the standing light 400 does not fall over even though a relatively heavy object is placed or hung on the bracket 491.

The charging interface 492 is also disposed on the connecting structure 481 so that the charging interface 492 is relatively close to the bracket 491. When the user needs to charge the mobile phone, the mobile phone is placed on the bracket 491, and the mobile phone is connected to the charging interface 492 through a data cable, thereby charging the mobile phone through the charging interface 492. The charging interface 492 is, for example, a universal serial bus (USB) interface. The battery pack on the standing light 400 may also be charged through the USB interface. Therefore, when it is inconvenient to charge the standing light 400, the battery pack may be charged by using the remaining power on the mobile phone or some other suitable devices.

The charging interface 492 is not limited to be on the connecting structure 481 and may also be at any position of the main body of the standing light 400. For example, the charging interface 492 may also be disposed on a handle housing 432 so that the charging interface 492 is relatively close to the bracket 491. To facilitate charging the mobile phone, a distance between the charging interface 492 and the bracket 491 may be set to be less than or equal to 50 centimeters so that an excessively long data cable does no need to be used. Furthermore, the distance between the charging interface 492 and the bracket 491 is greater than or equal to 30 centimeters.

Alternatively, in another example, the charging interface may also be disposed on the handle or the charging interface may also be disposed at other positions. The charging interface is disposed on the handle, which is convenient for the user to operate, and the handle may be configured to be relatively close to the bracket for supporting the mobile phone. The charging interface may be a type-c interface.

In another example, a power display for displaying the remaining power of the battery pack may also be disposed on the handle.

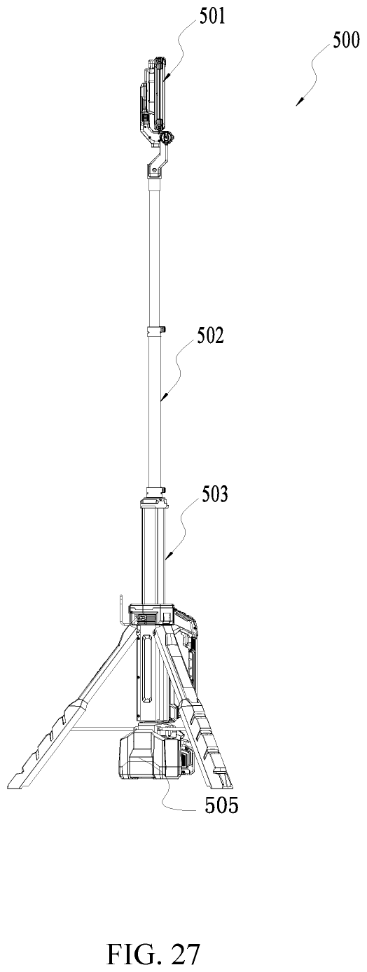

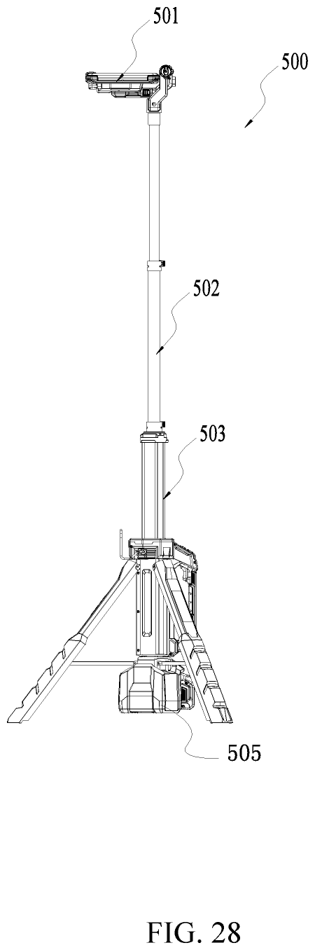

As shown in FIG. 27, a standing light 500 in a fifth example has substantially the same structure as the standing light 100 in the first example and can also achieve substantially the same function as the standing light 100 in the first example. As shown in FIGS. 27 and 28, a main difference between the standing light 500 and the standing light 100 in the first example is that a light assembly 501 can rotate relative to the first axis to a third state in addition to the first state and the second state. When the light assembly 501 is in the third state, the main light and the auxiliary light emit light upward. The light assembly 501 may also rotate to any state between the first state and the second state, and the light assembly 501 may also rotate to any state between the second state and the third state. A maximum angle range that the light assembly 501 can rotate relative to a support rod assembly 502 around the first axis is 270 degrees. In another example, the maximum angle range that the light assembly 501 can rotate relative to the support rod assembly 502 around the first axis may be greater than or equal to 100 degrees and less than or equal to 300 degrees.

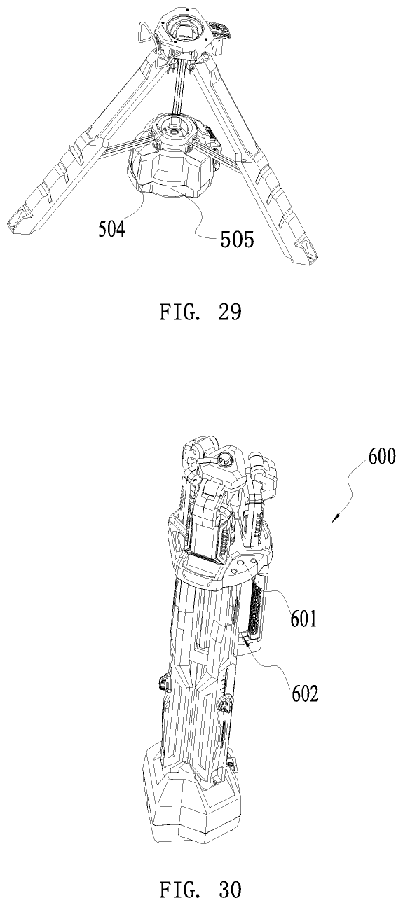

As shown in FIG. 29, in this example, a lower end of a first support rod 503 is further provided with a water blocking element 504, and the water blocking element 504 is disposed between the first support rod 503 and a base 505, so as to avoid water from flowing into the base 505 along the first support rod 503 or the wire, thereby protecting a circuit board in the base 505. The water blocking element 504 may be a rubber piece.

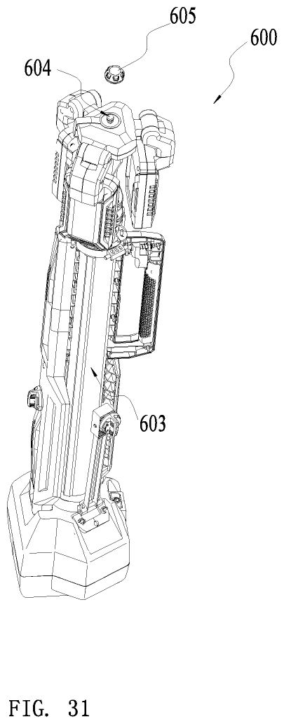

As shown in FIGS. 30 and 31, a standing light 600 in a sixth example has substantially the same structure as the standing light 100 in the first example and can also achieve substantially the same function as the standing light 100 in the first example. The following mainly introduces a difference between this example and the first example.

In this example, the standing light 600 further includes a shelf 601, and the shelf 601 is connected to a housing assembly 602. In another example, the shelf 601 may also be connected to a support rod assembly 603. The shelf 601 is used for the user to place other objects or tools, such as a mobile phone and a water glass, or place some tool accessories such as a wrench.

In this example, an upper end of the standing light 600 is further provided with a mounting portion 604, and the mounting portion 604 is used for detachably installing aids. For example, the mounting portion 604 is used for installing a rangefinder. The mounting portion 604 includes a mounting post, for example, a threaded post. Alternatively, in another example, the mounting portion 604 may also be a threaded hole. The standing light 600 further includes a protective cover 605 detachably connected to the mounting post.

The above illustrates and describes basic principles, main features, and advantages of the present disclosure. It is to be understood by those skilled in the art that the preceding example do not limit the present disclosure in any form, and technical solutions obtained by means of equivalent substitution or equivalent transformation fall within the scope of the present disclosure.

What is claimed is:

1. A standing light, comprising:
a light assembly comprising a light and a power supply access interface for accessing power;
a support rod assembly configured to support the light assembly;
a housing assembly connected to the support rod assembly, wherein the housing assembly or the support rod assembly is formed with a power access interface for being connected to a power supply; and
a mounting assembly configured to detachably install the light assembly to the support rod assembly;
wherein, when the light assembly is installed to the support rod assembly, the light assembly is capable of being powered by the power supply connected to the power access interface, and, when the light assembly is detached from the support rod assembly, the light assembly is capable of being detachably connected to a battery pack through the power supply access interface.

2. The standing light of claim 1, wherein the battery pack connected to the light assembly is capable of supplying power to a power tool.

3. The standing light of claim 1, wherein the mounting assembly is provided with a connecting structure for detachably connecting the light assembly to the mounting assembly and a power supply output interface for outputting power from the power access interface to the light assembly, and the power supply output interface is electrically connected to the power supply access interface when the light assembly is installed to the mounting assembly through the connecting structure.

4. The standing light of claim 3, wherein the housing assembly comprises a base disposed at a lower end of the support rod assembly and the mounting assembly is disposed at an upper end of the support rod assembly.

5. The standing light of claim 4, wherein a mounting portion for installing the battery pack is provided on the base and the battery pack is electrically connected to the power access interface when the battery pack is coupled to the mounting portion.

6. The standing light of claim 3, wherein the housing assembly further comprises a handle housing connected to the support rod assembly and the handle housing is formed with a handle for a user to hold.

7. The standing light of claim 3, wherein the light assembly is formed with a mating structure mating with the connecting structure and the battery pack is formed with a battery connecting base capable of being connected to the mating structure and a battery output interface capable of being electrically connected to the power supply access interface.

8. The standing light of claim 7, wherein the housing assembly is formed with a mounting portion for installing the battery pack, the battery connecting base mates with the mounting portion. and the battery output interface is electrically connected to the power access interface when the battery pack is connected to the mounting portion.

9. The standing light of claim 8, wherein the standing light is further provided with an alternating current access interface for accessing alternating current.

10. The standing light of claim 1, wherein a first switch for turning on the light is formed on the support rod assembly or the housing assembly and a second switch for turning on the light is formed on the light assembly.

11. The standing light of claim 1, wherein the support rod assembly comprises a first support rod extending substantially along a first straight line and a second support rod movable along the first straight line relative to the first support rod, the light assembly comprises a main light and an auxiliary light movably connected to the main light, the light assembly has a first state and a second state relative to the support rod assembly, the light assembly is at least partially disposed on an upper side of the support rod assembly when the light assembly is in the first state, and the auxiliary light is rotatable relative to the main light to a storage state in which the support rod assembly is at least partially disposed between the main light and the auxiliary light when the light assembly is in the second state.

12. The standing light of claim 11, wherein two auxiliary lights are provided, the light assembly forms a U-shaped region. and the support rod assembly is disposed within the U-shaped region when the auxiliary lights are in the storage state.

13. The standing light of claim 1, wherein the support rod assembly comprises a first support rod extending substantially along a first straight line and a second support rod movable relative to the first support rod, the housing assembly further comprises a handle housing for a user to hold, the standing light further comprises a switch for the user to operate to turn on the light, the handle housing is connected to the first support rod, and the switch is disposed on the handle housing.

14. The standing light of claim 13, wherein the handle housing is slidable relative to the first support rod to a first position and a second position along the first straight line.

15. The standing light of claim 14, wherein the housing assembly further comprises a power supply housing for setting the power access interface, the standing light further comprises a circuit board disposed in the power supply housing and a wire connecting the circuit board to the switch, the first support rod is formed with a through hole for the wire to pass through, and the through hole is disposed in the handle housing.

16. A standing light, comprising:
a light assembly comprising a light;
a support rod assembly configured to support the light assembly;
a housing assembly connected to the support rod assembly, wherein the housing assembly or the support rod assembly is formed with a power access interface for being connected to a power supply; and
a mounting assembly configured to detachably install the light assembly to the support rod assembly or the housing assembly;
wherein, when the light assembly is installed to the support rod assembly or the housing assembly, the light assembly is capable of being powered by the power supply connected to the power access interface.

17. A standing light, comprising:
a light assembly comprising a light and a power supply access interface for accessing power;
a support rod assembly configured to support the light assembly;
a housing assembly connected to the support rod assembly, wherein the housing assembly or the support rod assembly is formed with a power access interface for being connected to a power supply; and
a mounting assembly configured to detachably install the light assembly to the support rod assembly or the housing assembly;
wherein, when the light assembly is installed to the support rod assembly or the housing assembly, the light assembly is capable of being powered by the power supply connected to the power access interface, and, when the light assembly is detached from the support rod assembly or the housing assembly, the light assembly is capable of being detachably connected to a battery pack through the power supply access interface.

18. The standing light of claim 17, wherein the battery pack connected to the light assembly is further configured to be capable of supplying power to a power tool.

19. The standing light of claim 17, wherein the mounting assembly is provided with a connecting structure for detachably connecting the light assembly to the mounting assembly and a power supply output interface for outputting power from the power access interface to the light assembly and the power supply output interface is electrically connected to the power supply access interface when the light assembly is installed to the mounting assembly through the connecting structure.

20. The standing light of claim 17, wherein a first switch for turning on the light is formed on the support rod assembly or the housing assembly and a second switch for turning on the light is formed on the light assembly.
